(19) United States
(12) Patent Application Publication
(10) Pub. No.: US 2018/0323593 A1
(43) Pub. Date: Nov. 8, 2018

(54) ELECTRIC BOX WITH CONNECTING FLANGES

(71) Applicant: ABB Schweiz AG, Baden (CH)

(72) Inventors: Jeff R. Justis, Germantown, TN (US); Robert H. Osborn, Somerville, TN (US); William T. Custead, Lenoir City, TN (US)

(21) Appl. No.: 15/970,629

(22) Filed: May 3, 2018

Related U.S. Application Data
(60) Provisional application No. 62/501,354, filed on May 4, 2017.

(51) Int. Cl. H02G 3/12; H02G 3/08; H02G 1/00

(52) U.S. Cl. CPC H02G 3/12; H02G 3/081; H02G 1/00; H02G 3/086

(57) ABSTRACT

Connecting flanges are provided for use with an electrical box and a structural bracket. The connecting flanges have a side portion that is attached to the side of the electrical box. The connecting flanges also have a front portion that engages the structural bracket to secure the electrical box to the structural bracket. The connecting flanges may be used in pre-assembled and pre-wired electrical assemblies to simplify wiring at a building site.

### BACKGROUND

The present inventions relate generally to wiring electrical devices and buildings, and more particularly, to electrical boxes that house electrical devices and associated wiring.

Electrical boxes, also referred to as junction boxes, are used in building wiring to house electrical devices, such as light switches, electrical outlets, etc. Typically, the electrical box is mounted behind a wall and is attached to a stud, bracket, frame or other support structure within the wall. The rear portion of the electrical device and associated electrical connections are housed within the electrical box. A common type of electrical box is known as a 2-gang box, which is capable of housing two standard sized electrical devices. The front opening of a standard 2-gang box is about 4″ wide by 4″ high. Electrical boxes are made with different depths, but one common example has a depth of about 1½″.

The rear side of a conventional electrical box has a closed back side, although electrical boxes with an open back are also available. Circular knockouts are provided along the sides and back for accessing the inside of the box with building wiring. The wiring is connected inside the box to the electrical connections of the electrical devices. Various attachment holes are also provided through the sides and back of the box for attaching the box to the support structure. During installation, a front cover plate is attached to the front of the electrical box or to a structural bracket located between the front cover plate and the electrical box. The front portion of the electrical device typically extends through the front cover plate so that building occupants can access and use the electrical device for its intended purpose, such as turning a light on and off or plugging an electrical cord into an outlet. The front cover plate also covers the electrical box so that the internal wiring and the rear portion of the electrical device are enclosed within the electrical box.

One concern with conventional electrical boxes is the cost of installation. Installation of electrical boxes and their related wiring of the electrical devices is frequently performed by licensed electricians who have high labor rates. Thus, it is desirable to simplify the installation steps required at the building site in order to reduce building labor costs. Simplified and easier installation may also be helpful in reducing mistakes in building installation, which can result in re-installation costs and other problems.

### SUMMARY

Connecting flanges are described for securing an electrical box to a structural bracket. The connecting flanges may be used in pre-assembled and pre-wired electrical assemblies to secure the electrical box to the structural bracket during wiring of electrical leads to building wiring. In the described embodiments, a side portion of the connecting flange is attached to the side of the electrical box. A front portion extending generally orthogonal from the side portion engages the structural bracket to secure the electrical box.

### BRIEF DESCRIPTION OF SEVERAL VIEWS OF THE DRAWINGS

The invention may be more fully understood by reading the following description in conjunction with the drawings, in which:

FIG. 1 is a perspective view of a first embodiment of a connecting flange;

FIG. 2 is a front view of the first embodiment of the connecting flange;

FIG. 3 is a side view of the first embodiment of the connecting flange;

FIG. 4 is a rear perspective view of the first embodiment of the connecting flange attached to an electrical box and a structural bracket;

FIG. 5 is a front perspective view of the first embodiment of the connecting flange attached to the electrical box and the structural bracket;

FIG. 6 is a perspective view of a second embodiment of a connecting flange;

FIG. 7 is a front view of the second embodiment of the connecting flange;

FIG. 8 is a side view of the second embodiment of the connecting flange;

FIG. 9 is a front view of a third embodiment of the connecting flange;

FIG. 10 is a rear perspective view of the second embodiment of the connecting flange attached to an electrical box and a structural bracket;

FIG. 11 is a front perspective view of the second embodiment of the connecting flange attached to the electrical box and the structural bracket;

FIG. 12 is a perspective view of a fourth embodiment of a connecting flange;

FIG. 13 is a front view of the fourth embodiment of the connecting flange;

FIG. 14 is a side view of the fourth embodiment of the connecting flange;

FIG. 15 is a rear perspective view of the fourth embodiment of the connecting flange attached to an electrical box and a structural bracket;

FIG. 16 is a front perspective view of the fourth embodiment of the connecting flange attached to the electrical box and the structural bracket;

FIG. 17 is a perspective view of a fifth embodiment of a connecting flange;

FIG. 18 is a front view of the fifth embodiment of the connecting flange;

FIG. 19 is a side view of the fifth embodiment of the connecting flange;

FIG. 20 is a rear perspective view of the fifth embodiment of the connecting flange attached to an electrical box and a structural bracket;

FIG. 21 is a front perspective view of the fifth embodiment of the connecting flange attached to the electrical box and the structural bracket;

FIG. 22 is a perspective view of a sixth embodiment of a connecting flange;

FIG. 23 is a front view of the sixth embodiment of the connecting flange;

FIG. 24 is a side view of the sixth embodiment of the connecting flange;

FIG. 25 is a rear perspective view of the sixth embodiment of the connecting flange attached to an electrical box and a structural bracket with a slot;

FIG. 26 is a front perspective view of the sixth embodiment of the connecting flange attached to the electrical box and the structural bracket with the slot;

FIG. 27 is a rear perspective view of the sixth embodiment of the connecting flange attached to an electrical box and a structural bracket with individual slots;

FIG. 28 is a front perspective view of an electrical assembly with the sixth embodiment of the connecting flange attached to the electrical box and the structural bracket with the individual slots; and

FIG. 29 is a flow chart of a method of using a pre-assembled and pre-wired electrical assembly.

### DETAILED DESCRIPTION

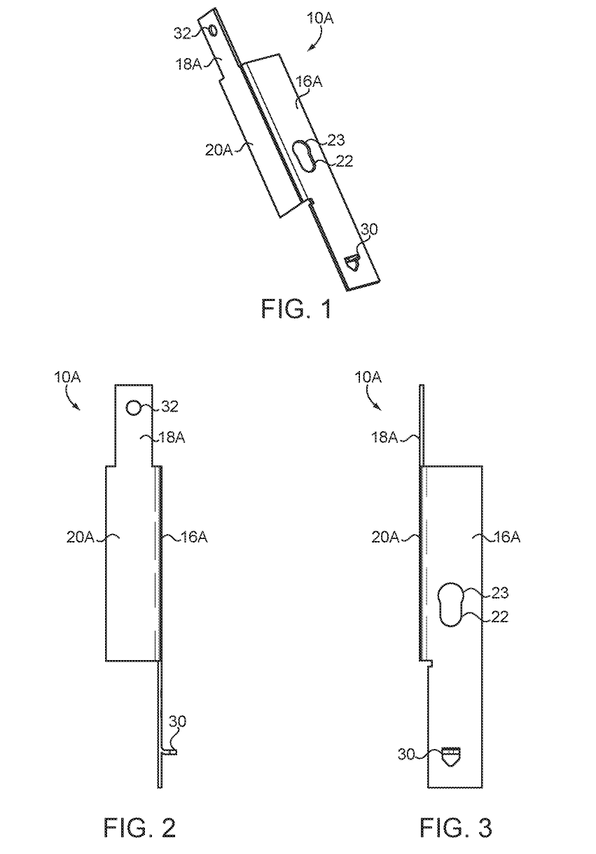

Referring now to the figures, and particularly FIGS. 1-5, a connecting flange 10A is shown for securing an electrical box 12 to a structural bracket 14A. Although various types of electrical boxes 12 may be used with the connecting flange 10A, a conventional closed-back 2-gang 4″×4″ electrical box 12 is shown in the figures. As shown in FIGS. 1-3, the connecting flange 10A includes a side portion 16A, a front portion 18A, and a connecting portion 20A connecting the side and front portions 16A, 18A together. Preferably, the front and connecting portions 18A, 20A are oriented generally orthogonal from the side portion 16A. That is, the front and connecting portions 18A, 20A may be angled with respect to the side portion 16A within a range of 80° to 100° (which is considered herein to be generally orthogonal). The connecting flange 10A may be made of shaped metal, such as 0.032″ thick steel. Thus, in the embodiments shown, the connecting portion 20A is bent relative to the side portion 16A. In the embodiment of FIGS. 1-5, the front portion 18A may be an extension from the connecting portion 20A that is flat and aligned with the connecting portion 20A.

In order to attach the connecting flange 10A to the electrical box 12, the connecting flange 10A is provided with a hole 22 extending through the side portion 16A. If desired, the holes 22 in the connecting flange 10A may be slotted holes 22 with an enlarged end 23 that allows the head of the screw 26 to pass through. As shown in FIG. 5, each side of the electrical box 12 may be provided with two holes 24 that are equally offset from the centerline of the electrical box 12. Preferably, a screw 26 (e.g., a self-tapping #10 screw) is used to attach the connecting flange 10A to the electrical box 12 by extending the screw 26 through the hole 22 in the connecting flange 10A and threading the screw 26 into one of the holes 24 in the side of the electrical box 12. Thus, the head of the screw 26 contacts the side portion 16A. Therefore, when the connecting flange 10A is attached to the electrical box 12, the side portion 16A of the connecting flange 10A engages the outside side surface 28 of the electrical box 12. In order to prevent the connecting flange 10A from rotating around the screw holes 22, 24, the connecting flange 10A may also be provided with a tab 30 extending generally orthogonal from the side portion 16A toward the electrical box 12. When the connecting flange 10A is attached to the electrical box 12, the tab 30 extends into the second hole 24 in the side of the electrical box 12 in order to prevent rotation of the connecting flange 10A.

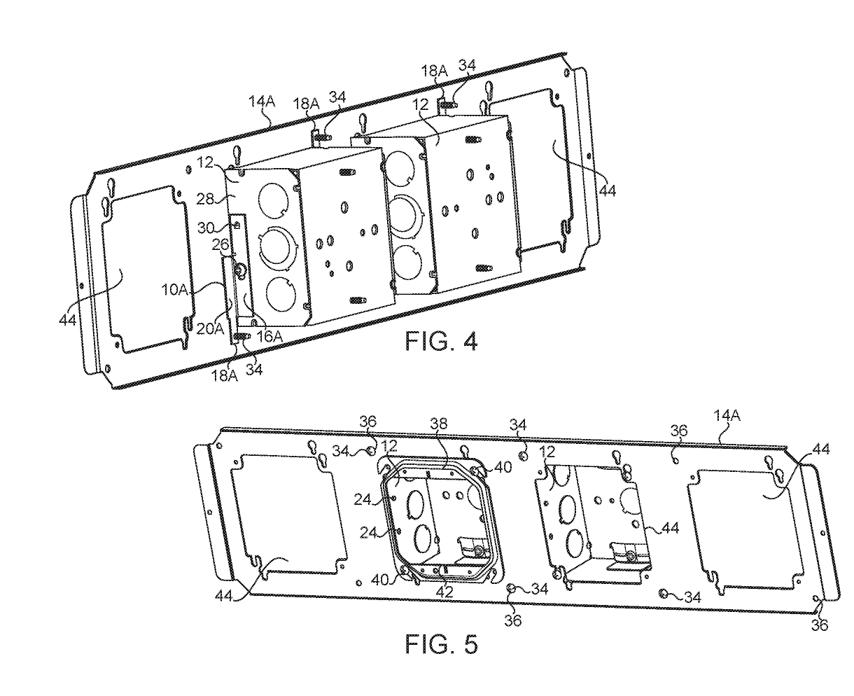

As shown in FIG. 4, two connecting flanges 10A are preferably attached to the electrical box 12 with each connecting flange 10A attached to an opposing side of the electrical box 12. It may also be preferable for the two connecting flanges 10A to be attached in reverse orientation relative to each other. In the embodiment of FIGS. 1-5, the front surface of the front portion 18A is preferably generally aligned with the front edge of the electrical box 12 when the connecting flange 10A is attached to the electrical box 12. That is, there is preferably no more than a 0.080″ step between the front surface of the front portion 18A and the front edge of the electrical box 12. As shown in FIG. 4, the front surface of the front portion 18A engages the rear surface of the structural bracket 14A in this embodiment. The front portion 18A may be provided with a hole 32 to secure the connecting flange 10A to the structural bracket 14A. Thus, in this embodiment a screw 34 (e.g., a self-tapping #10 screw) may extend through a hole 36 in the structural bracket 14A and is threaded into the hole 34 in the front portion 18A so that the head of the screw 34 contacts the structural bracket 14A.

As shown in FIG. 5, the electrical box 12 is aligned with an opening 44 in the structural bracket 14A. A front cover plate 38 is typically attached to the structural bracket 14A with screws 40 that pass through the front cover plate 38 and structural bracket 14A and are threaded into the electrical box 12 with the head of the screw 40 contacting the cover plate 38. The front portion of the electrical device typically extends out of an opening 42 in the front cover plate 38, and the rear portion of the electrical device is disposed behind the front cover plate 38 and within the electrical box 12. As is understood by those in the art, the wiring and electrical connections for the electrical device are housed within the electrical box 12 behind the front cover plate 38. As shown in FIG. 5, the front portion screws 34 may be located outside of the periphery of the front cover plate 38.

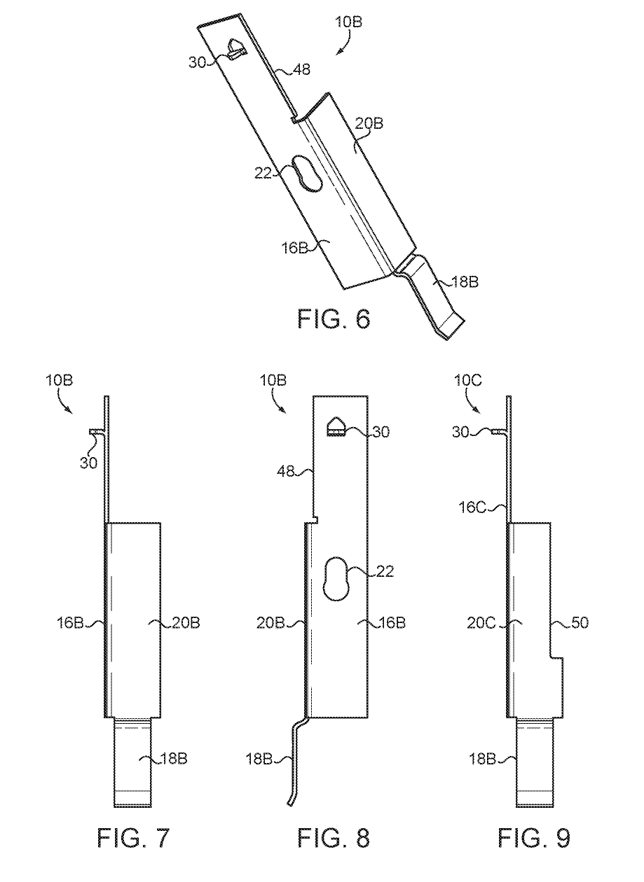

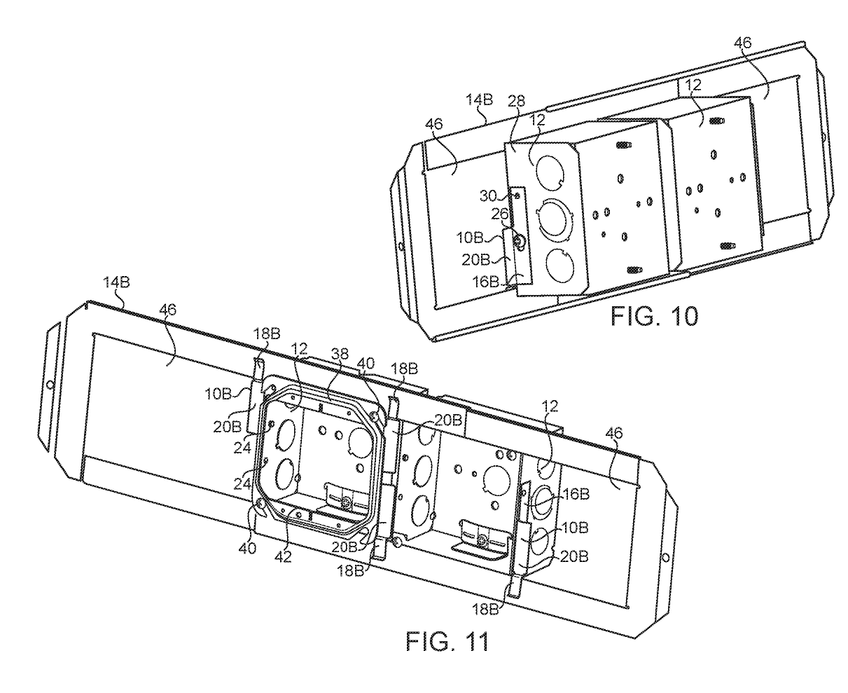

Turning now to FIGS. 6-8 and 9-10, another embodiment of a connecting flange 10B is shown. Where features of this embodiment and the following embodiments have already been described, descriptions will not be repeated for the sake of clarity. As shown in FIG. 11, in this embodiment the front portion 18B of the connecting flange 10B engages the front surface of the structural bracket 14B to secure the electrical box 12 to the structural bracket 14B. As shown in FIG. 8, the front portion 18B may be stepped forward relative to the connecting and side portions 20B, 16B. Thus, when the connecting flange 10B is attached to the electrical box 12, the front portion 18B is stepped forward from the front edge of the electrical box 12. Unlike the embodiment of FIGS. 1-5 where screws 34 are preferably used to attach the connecting flange 10A to the structural bracket 14A, it may be desirable in this embodiment to not provide solid fixation. Thus, the electrical box 12 may be more easily secured to the structural bracket 14B, and the electrical box 12 may be adjusted relative to the structural bracket 14B. For instance, as shown in FIGS. 10-11, where the structural bracket 14B includes a large slot 46 capable of accommodating multiple electrical boxes 12, the front portion 18B of the connecting flange 10B may allow the electrical box 12 to slide along the slot 46 to horizontally adjust the position of the electrical box 12. In order to secure the electrical box 12 to the structural bracket 14B, the electrical box 12 may be rotated at an angle relative to the slot 46 in the structural bracket 14B. The front portions 18B of the connecting flanges 10B may then be inserted through the slot 46 from the back of the structural bracket 14B by pushing the electrical box 12 forward. When the front edge of the electrical box 12 is engaging the rear surface of the structural bracket 14B, the electrical box 12 can be rotated back to align the box 12 with the slot 46 and engage the front portions 18B with the front surface of the structural bracket 14B. In this embodiment, when the front cover plate 38 is attached to the structural bracket 14B and electrical box 12, the structural bracket 14B will be squeezed between the cover plate 38 and electrical box 12. Thus, the cover plate 38 to electrical box 12 attachment prevents the electrical box 12 from sliding horizontally along the slot 46. As shown in FIG. 11, the front cover plate 38 may cover the front portions 18B after the front cover 38 is installed.

As shown in FIG. 10, it may be preferable for the connecting portion 20B to extend along less than half the length of the side of the electrical box 12. In other words, in FIG. 10 the connecting portion 20B of one connecting flange 10B on one side of the box 12 occupies the top half of the electrical box 12 with the bottom half being left unoccupied. Similarly, the connecting portion 20B of the other connecting flange 10B on the other side of the box 12 occupies the bottom half of the electrical box 12 with the top half being left unoccupied. As a result, as shown FIG. 10, two electrical boxes 12 can be located next to each other with the connecting portions 20B of adjacent connecting flanges 10B overlapping each other.

In the embodiment of FIGS. 6-8 and 10-11, the side portion 16B is provided with a cutout 48 along the front and bottom of the side portion 16B as shown in FIG. 8. As shown in FIG. 10, this allows the connecting portion 20B of an adjacent connecting flange 10B to be received by the cutout 48 in the side portion 16B. In other words, the outer edge of the connecting portion 20B may be straight and may be located directly adjacent the adjacent electrical box 12. Thus, the connecting portion 20B may cover the lower part of the side portion 16B of an adjacent connecting flange 10B.

Turning to FIG. 9, the connecting portion 20C may alternately be provided with a cutout 50 along the bottom and outer edge to receive the bottom part of an adjacent side portion 16C. Like the embodiment of FIGS. 6-8 and 10-11, this allows the connecting flanges 10C to be located next to adjacent electrical boxes 12. However, in this embodiment the lower part of the side portion 16C may extend farther forward without interfering with the adjacent connecting portion 20C due to the cutout 50 in the connecting portion 20C.

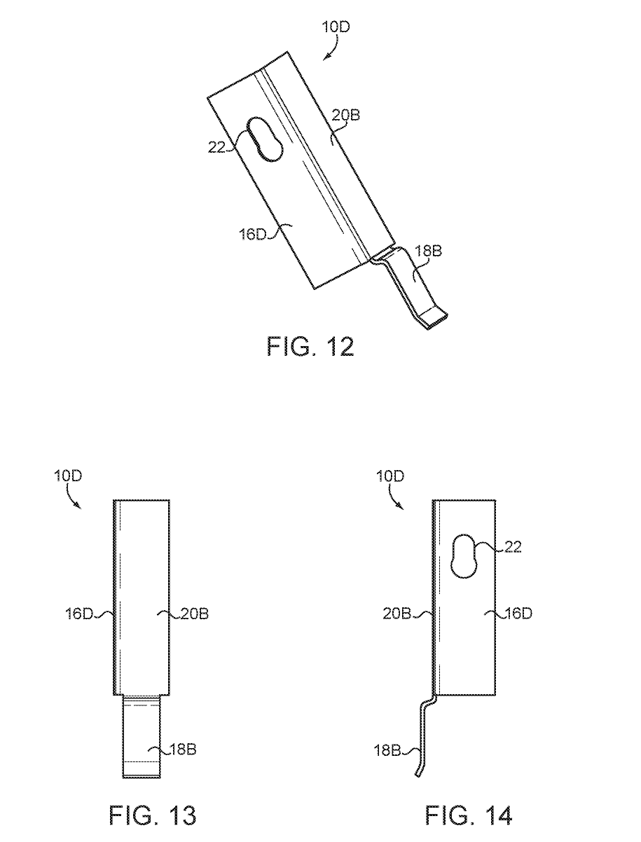

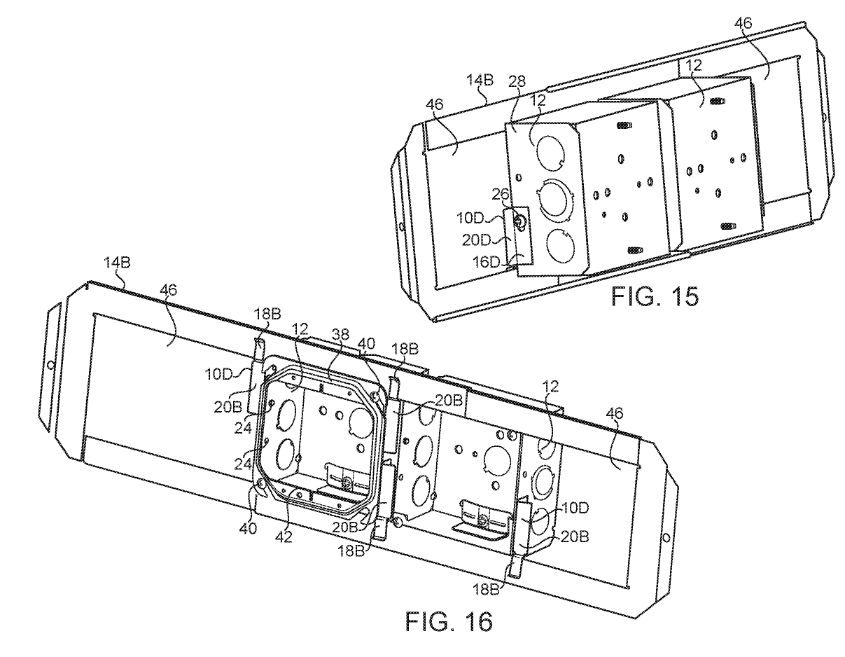

Turning to FIGS. 12-16, it is also possible to remove the lower part of the side portion 16D of the connecting flange 10D. Thus, in this embodiment, the connecting flange 10D itself extends along less than half the length of the side of the electrical box 12. Therefore, two electrical boxes 12 can be located next to each other with the connecting flanges 10D overlapping each other. In this embodiment, cutouts are unnecessary for receiving portions of adjacent connecting flanges 10D since each connecting flange 10D occupies less than half of a side of an electrical box 12. If the electrical box 12 is provided with two off-center holes 24 as described above, this may result in the anti-rotation tab 30 being removed so that the connecting flange 10D is attached to the electrical box 12 with a screw 26 through the hole 22 in the side portion 16D but without use of an anti-rotation tab 30 in the second hole 24. However, other means of preventing rotation may be used if desired.

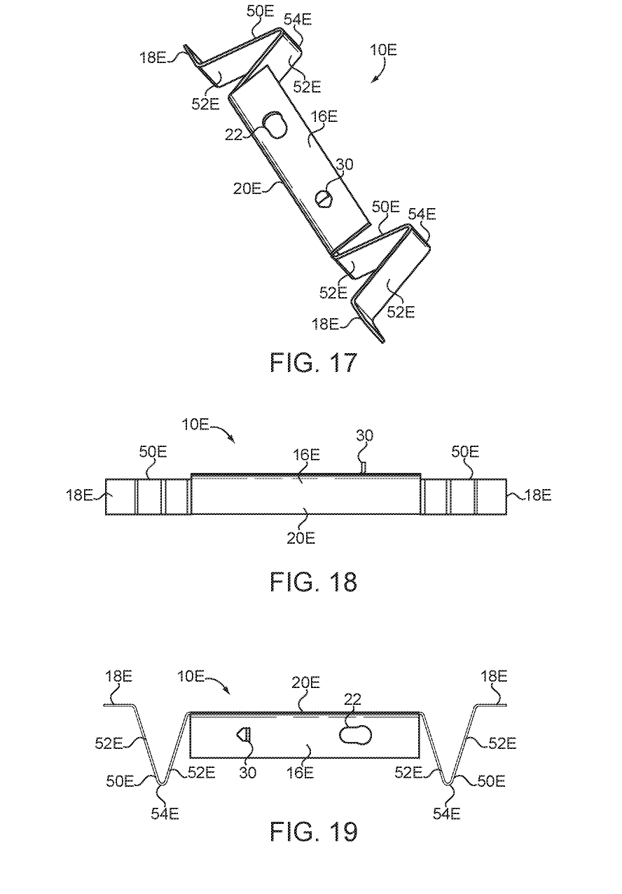

Turning to FIGS. 17-21, the connecting flange 10E may also be provided with a spring portion 53 which is integral with the connecting flange 10E. The spring portion 50E extends between the connecting portion 20E and the front portion 18E so that the arms 52E of the spring portion 50E extend rearward from the connecting portion 20E and the front portion 18E. More generally, the spring portion 50E is between the side portion 16E and the front portion 18E. The bend 54E in the spring portion 50E is preferably generally orthogonal with respect to the side portion 16E and is located rearward from the front edge of the electrical box 12 and interconnects the arms 52E at the ends thereof. Thus, the spring portion 50E biases the front portion 18E outward along the direction of the side portion 50E and side surface of the electrical box 12.

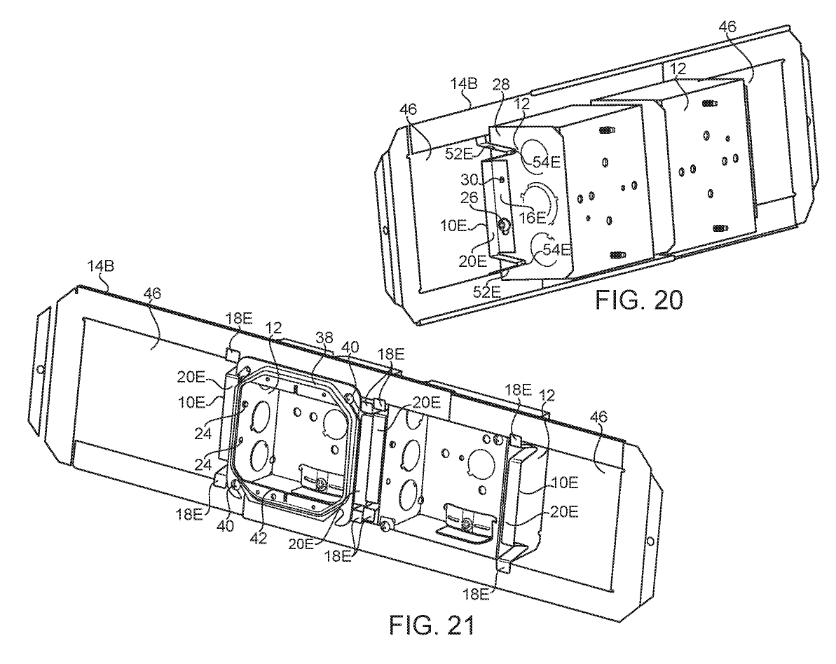

In the embodiment shown, two front portions 18E may be provided on the connecting flange 10E to provide four point contact (with two connecting flanges 10E) with the structural bracket 14B. Thus, the connecting portion 20E extends across the centerline of the electrical box 12 and extends along a majority of the length of the side of the electrical box 12. Like the embodiments above, a screw 26 may be used to attach the side portion 16E to the outside side surface 28 of the electrical box 12 with the screw 26 extending through the hole 22 in the side portion 16E and threaded into one of the holes 24 in the side of the electrical box 12. Preferably, the head of the screw 26 contacts the outside of the side portion 16E of the connecting flange 10E. The connecting flange 10E may also have an anti-rotation tab 30 that extends through the other hole 24 in the electrical box 12. In order to secure the electrical box 12 to the structural bracket 14B, the front portion 18E may be pressed inward toward the center of the electrical box 12 so that the outer edge of the front portion 18E clears the slot 46 in the structural bracket 14B. (In FIG. 21, the middle connecting flanges 10E are shown with the front portions 18E pressed inward for illustration.) The electrical box 12 may then be pushed forward from the rear of the structural bracket 14B to push the front portion 18E through the slot 46. The front portion 18E is then released so that the front portion 18E engages the front surface of the structural bracket 14B. Thus, the front portion 18E is biased toward the structural bracket 14B by the spring portion 50E. If desired, the spring portion 50E itself may engage and apply pressure to the edge of the slot 46 of the structural bracket 14B. Where four front portions 18E are provided as shown, the electrical box 12 may also be secured by inserting two of the front portions 18E (e.g., top or bottom) through the slot 46 without biasing the spring portions 50E by angling the electrical box 12. The other two front portions 18E may then be pressed against the spring portions 50E while rotating the electrical box 12 against the structural bracket 14B before releasing the front portions 18E.

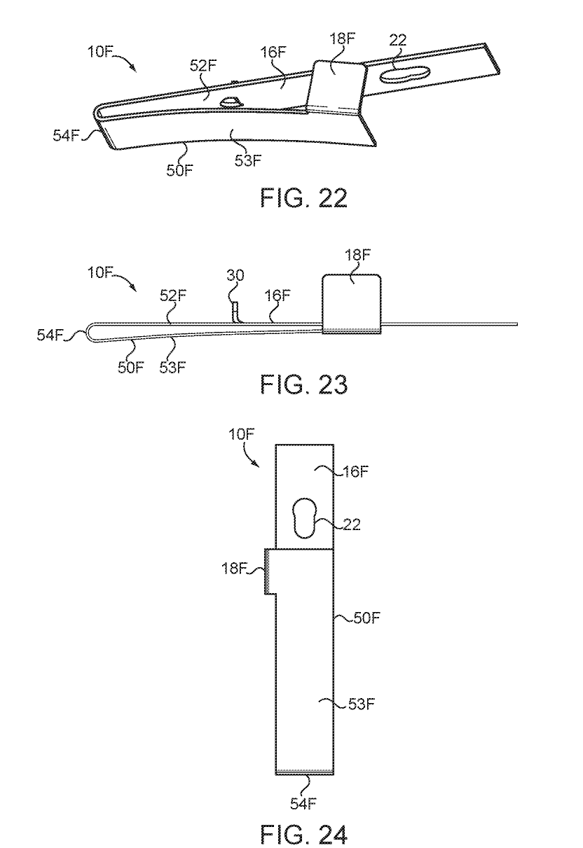

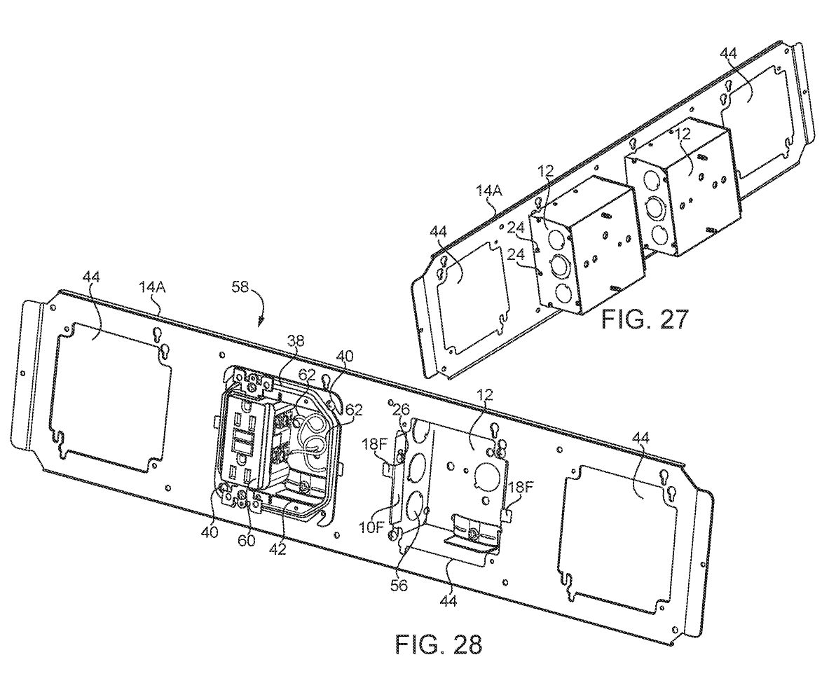

Turning to FIGS. 22-28, another embodiment of the connecting flange 10F may be attached to the inside of the electrical box 12. Like the previous embodiment, the connecting flange 10F is provided with a spring portion 50F between the side portion 16F and the front portion 18F. However, the direction of bias differs. That is, the spring portion 50F biases the front portion 18F outward in a direction that is generally orthogonal with respect to the side portion 16F and side surface of the electrical box 12.

As shown, the side portion 16F engages the inside side surface 56 of the electrical box 12. The side portion 16F may be attached to the side of the electrical box 12 with a screw 26 that extends through the hole 22 in the side portion 16F and threaded into one of the holes 24 in the electrical box 12. Preferably, the head of the screw 26 is inside the box 12 and contacts the side portion 16F. As shown, the hole 22 in the side portion 16F is through an extended portion that extends past the spring portion 50F and the front portion 18F so that the screw 26 does not interfere with the spring portion 50F and the front portion 18F. The anti-rotation tab 30 may be under the spring portion 50F and extends through the other hole 24 in the electrical box 12. The first spring arm 52F may be considered to be part of the side portion 16F, and the second arm 53F may overlap the side portion 16F. Thus, the bend 54F in the spring 50F is generally parallel (i.e., within 10°) to the side portion 16F and side surface of the electrical box 12. The front portion 18F is bent outward at the end of the second arm 53F to extend outward past the side portion 16F when the spring 50F is unbiased.

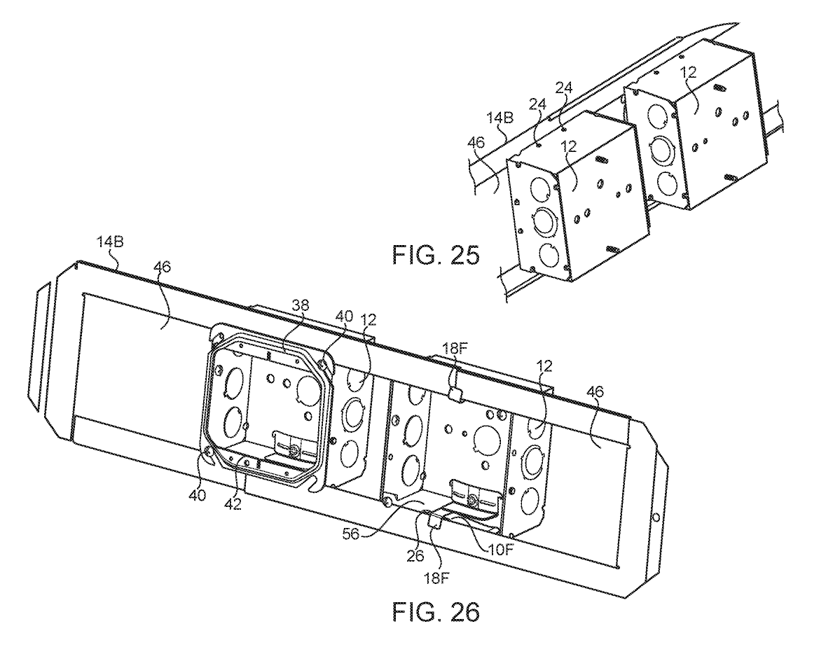

As shown in FIGS. 26 and 28, the front portion 18F secures the electrical box 12 to the structural bracket 14A,B by engaging the front surface of the structural bracket 14A,B. In order to secure the electrical box 12, one or both of the front portions 18F may be pressed inward against the spring portions 50F. The electrical box 12 may then be pushed against the back of the structural bracket 14A,B to push the front portions 18F through the slot 46 or opening 44 in the structural bracket 14A,B. The front portions 18F may then be released to engage the front surface of the structural bracket 14A,B. As shown in FIGS. 25-26, the connecting flanges 10F attached to the inside of the electrical box 12, and attached to the top and bottom of the electrical box 12, may allow the electrical boxes 12 to be positioned closer to each other (i.e., directly adjacent each other). Although the two boxes 12 are shown in FIGS. 25-26 separated from each other, it is understood that the boxes 12 could be slid against each other if desired. As illustrated in FIGS. 25-28, any of the disclosed connecting flanges 10 may be used with a structural bracket 14B having an elongated slot 46 for multiple electrical boxes 12 or a structural bracket 14A having a single opening 44 for each electrical box 12.

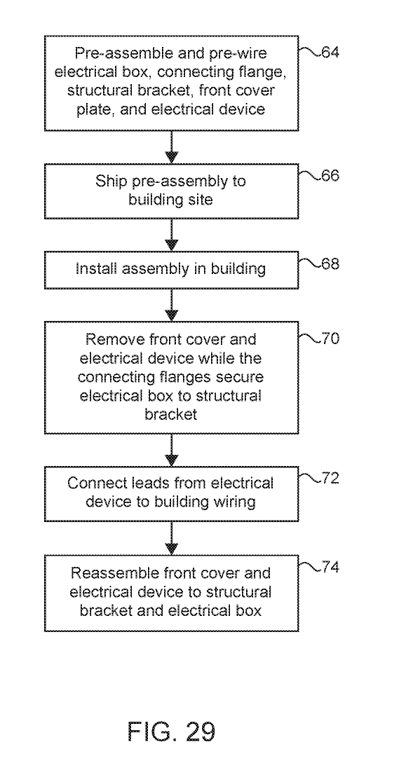

The described connecting flanges 10 improve upon conventional electrical assemblies and wiring techniques by providing an independent attachment of the electrical box 12 to the structural bracket 14. For instance, in some situations it may be desirable to pre-assemble and pre-wire an electrical assembly 58 prior to shipping the assembly to a building site. A preferred method of using a pre-assembled/pre-wired electrical assembly is shown in FIG. 29. For example, as shown in FIG. 28, the electrical box 12, connecting flanges 10, structural bracket 14, front cover plate 38 and electrical devices 60 may be completely assembled together as an electrical assembly 58, and the electrical devices 60 may be pre-wired with leads 62 for subsequent connection to the building wiring (64). In such a case, the electrical device leads 62 will typically be packaged within the electrical box 12 during pre-assembly and pre-wiring. The assembly 58 is then shipped to a building site (66) where the assembly 58 is installed in a wall or other structure of the building (68). At the building site, the building electrician then needs to access the electrical device leads 62 in order to connect the leads 62 to the wiring of the building.

While it has been known in these situations to use electrical boxes with an open back, which allows the building electrician to access the electrical device leads through the open back, there can be some disadvantages with this arrangement. For example, there may be situations where the back of the electrical box is not readily accessible due to the location of the wall, internal wall bracing or other obstacles. In addition, closed-back boxes 12 are much cheaper and ubiquitous in the market than open-back boxes.

However, when closed-back electrical boxes 12 are used in pre-assembled/pre-wired situations, building electricians must open the front of the electrical box 12 by removing the front cover plate 38 and electrical devices 60 in order to access the leads 62 packaged within the electrical box 12 (70). Because the front cover plate screws 40 are the sole attachment between the electrical box 12 and the structural bracket 14 in conventional systems, removal of the front cover 38 risks the possibility that the electrical box 12 may come loose from the structural bracket 14 and make reassembly more difficult. The described connecting flanges 10 overcome this concern by providing a separate attachment between the electrical box 12 and the structural bracket 14. Thus, the front cover plate 38 and electrical device 60 may be removed to access the leads 62 packaged in the electrical box 12. However, during this step the electrical box 12 remains secured to the structural bracket 14 by the connecting flanges 10. After the leads 62 have been accessed and wired to the building wiring (72), the electrical device 60 and front cover 38 may then be reassembled to the structural bracket 14 and the electrical box 12 without having to reattach a loose electrical box (74).

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A connecting flange for an electrical box, comprising:
a side portion adapted to engage a side surface of the electrical box;
a hole extending through the side portion and adapted to attach the side portion to the side surface of the electrical box;
a front portion extending generally orthogonal from the side portion;
wherein the front portion is adapted to engage a structural bracket to secure the electrical box to the structural bracket.

2. The connecting flange according to claim 1, wherein a front surface of the front portion is generally aligned with a front edge of the electrical box when the connecting flange is attached to the electrical box, said front surface engaging a rear surface of the structural bracket.

3. The connecting flange according to claim 2, wherein the front portion comprises a hole extending therethrough, the connecting flange being secured to the structural bracket with a screw extending through the hole and through a hole in the structural bracket.

4. The connecting flange according to claim 1, wherein the front portion is stepped forward from a front edge of the electrical box when the connecting flange is attached to the electrical box, said front portion engaging a front surface of the structural bracket.

5. The connecting flange according to claim 4, wherein the front portion allows the electrical box to slide along a slot in the structural bracket.

6. The connecting flange according to claim 4, further comprising a spring portion between the side portion and the front portion, the spring portion biasing the front portion toward the structural bracket.

7. The connecting flange according to claim 6, wherein the spring portion applies pressure against the structural bracket.

8. The connecting flange according to claim 6, wherein the spring portion biases the front portion along a direction of the side surface of the electrical box.

9. The connecting flange according to claim 6, wherein the spring portion biases the front portion along a direction generally orthogonal to the side surface of the electrical box.

10. The connecting flange according to claim 9, wherein the side portion is adapted to engage an inside side surface of the electrical box and the spring portion biases the front portion outward.

11. The connecting flange according to claim 1, wherein the side portion is adapted to engage an outside side surface of the electrical box.

12. The connecting flange according to claim 1, wherein the side portion further comprises a tab adapted to engage a hole in the electrical box, the tab restraining the connecting flange from rotating around the hole in the side portion.

13. The connecting flange according to claim 1, further comprising a connecting portion connecting the side portion to the front portion, the connecting portion extending generally orthogonal from the side portion.

14. The connecting flange according to claim 13, wherein the connecting portion extends along less than half of the side surface of the electrical box, a corresponding connecting portion of an adjacent connecting flange attached to another electrical box being adapted to overlap with the connecting portion.

15. The connecting flange according to claim 14, wherein the connecting portion comprises a cutout adapted to receive a portion of a corresponding side portion of the adjacent connecting flange attached to the another electrical box.

16. The connecting flange according to claim 14, wherein the side portion comprises a cutout adapted to receive a portion of a corresponding connecting portion of the adjacent connecting flange attached to the another electrical box.

17. The connecting flange according to claim 14, wherein the connecting flange extends along less than half of the side surface of the electrical box, the adjacent connecting flange attached to the another electrical box being adapted to overlap with the connecting flange.

18. An electrical box comprising two connecting flanges according to claim 1 attached to opposing side surfaces of the electrical box.

19. The electrical box according to claim 18, wherein the connecting flanges are attached in a reversed orientation relative to each other.

20. The electrical box according to claim 18, wherein the electrical box is a 2-gang 4″×4″ electrical box.

21. A pre-wired electrical assembly comprising two connecting flanges according to claim 1 attached to opposing side surfaces of a closed-back electrical box, and further comprising:
a structural bracket, the front portion of each connecting flange securing the electrical box to the structural bracket;
a front cover plate attached to the structural bracket with screws and having an opening in communication with an inside of the closed-back electrical box;
an electrical device attached to the front cover plate within the opening thereof, a front portion of the electrical device extending outside of the front cover plate and a rear portion of the electrical device extending inside the closed-back electrical box; and
electrical leads connected to the electrical device, the electrical leads being housed within the closed-back electrical box without being connected to wiring of a building.

22. A method of using a pre-assembled and pre-wired electrical assembly, comprising:
assembling and wiring an electrical assembly comprising a closed-back electrical box, connecting flanges attached to opposing side surfaces of the closed-back electrical box, a structural bracket, a front portion of each connecting flange securing the electrical box to the structural bracket, a front cover plate attached to the structural bracket with screws and having an opening in communication with an inside of the closed-back electrical box, an electrical device attached to the front cover plate within the opening thereof, a front portion of the electrical device extending outside of the front cover plate and a rear portion of the electrical device extending inside the closed-back electrical box, and electrical leads connected to the electrical device, the electrical leads being housed within the closed-back electrical box without being connected to wiring of a building;
shipping the electrical assembly to a building site;
installing the electrical assembly in a building structure at the building site;
removing the front cover and electrical device from the structural bracket, the connecting flanges retaining securement of the electrical box to the structural bracket;
connecting the leads to building wiring; and
reassembling the front cover plate and electrical device to the structural bracket.
